(19) United States
(12) Patent Application Publication
(10) Pub. No.: US 2012/0132830 A1
(43) Pub. Date: May 31, 2012

(54) OPTICAL DETECTOR FOR DETECTING RADIATION

(75) Inventors: Tanya Mary Monro, Urrbrae (AU); Heike Ebendorff-Heidepriem, Dovers Gardens (DE); Christopher Andris Gregory Kalnins, Frewville (AU); Ricardo Nazar, Modbury Heights (AU); Timothy Priest, Washington, DC (US); Nigel Antony Spooner, Prospect (AU)

(73) Assignees: Commonwealth of Australia (As represented by the Defence Science & Technology Organisation), Canberra ACT (AU); Adelaide Research & Innovation Pty Ltd, Adelaide (AU)

(21) Appl. No.: 12/955,067

(22) Filed: Nov. 29, 2010

(51) Int. Cl. G01T 1/16

(52) U.S. Cl. 250/484.4; 250/484.2

(57) ABSTRACT

The present disclosure provides an optical detector for detecting radiation. The optical detector includes an optical light guide that incorporates a sensing region. The sensing region includes a sensing material that emits luminescence light when the sensing material is exposed to suitable ionizing radiation and accrues trapped charge which is released and produces optically stimulated luminescence (OSL) when the sensing material is optically stimulated. The optical detector also includes a light source for optically stimulating the sensing material and a light detector for detecting the OSL. The optical light guide is arranged to guide light through the sensing region and between the sensing region and the luminescence light detector.

### FIELD OF THE INVENTION

The present invention broadly relates to an optical detector for detecting radiation and relates particularly, though not exclusively, to an optical detector for detecting ionizing radiation.

### BACKGROUND OF THE INVENTION

Ionizing radiation is a consequence of, or required for, a range of applications in different fields of technology. For example, ionizing radiation is frequently used for a range of medical applications, such as cancer treatment, but is also naturally occurring.

The detection of a radiation dose to which a person, such as a patient, is exposed, is important for various reasons. Known radiation detection devices include for example scintillators, which are unsuitable for low-dose environmental dosimetry and have a relative low signal relative to a noise level.

Recently optically stimulated luminescence (OSL) has been used for detection of such radiation. The ionizing radiation generates electron-hole pairs that are metastably trapped at defect sites of the OSL material for lifetimes ranging from seconds to hours. The OSL material is arranged such that recombination of the generated electron hole pairs can be stimulated by exposing the OSL material to suitable light. The electron hole pairs will then recombine relatively rapidly, which results in the emission of a light pulse from the OSL material. The OSL intensity integrated over time is largely proportional to the dose of the ionizing radiation (at least for a typical radiation dose range) and the radiation dose may be determined by comparing the integrated OSL intensity with that of a reference sample.

Such OSL-based device may include an OSL chip and an optical fiber. The OSL chip includes a small OSL material portion that may have a length of the order of 1 mm. The optical fiber and the OSL material are spliced and the emitted OSL is directed to a light detector. Such available OSL detectors have advantages compared with scintillation-based detectors, but still suffer from an insufficient signal-to-noise ratio and consequently are not suitable for detection of low dose radiation. Further, Al₂O₃:C is often used for such applications and this material has a very long bleaching time. In other words, Al₂O₃:C-based OSL detectors are not suitable for applications in which measurements must be repeated within short time intervals. There is a need for technological advancement.

### SUMMARY OF THE INVENTION

The present invention provides in a first aspect an optical detector for detecting ionizing radiation, the detector comprising:

an optical light guide incorporating a sensing region, the sensing region comprising a sensing material that accrues trapped charge under exposure to the ionizing radiation and then emits stimulated luminescence when the sensing material is stimulated; and

a luminescence light detector for detecting the emitted luminescence;

wherein the optical light guide is arranged to guide light through the sensing region and between the sensing region and the luminescence light detector.

The optical detector may comprise a light source for optically stimulating the accrued charges of the sensing material thereby emitting optically stimulated luminescence (OSL) radiation.

The optical light guide typically is integrally formed and consequently typically does not include any regions at which portions of the optical light guide are spliced together or are otherwise joined.

In one specific embodiment the optical light guide is an optical fiber that comprises a core and a cladding region. The sensing region typically forms a part of the core region of the optical fiber, but may also include the cladding region of the optical fiber. The sensing region may extend along the entire length of the optical fiber. The sensing material of the sensing region may have a sensing property that is substantially constant along the length of the sensing region. Alternatively, the sensing material may have the property that changes along the optical fiber. For example, the sensing region may comprise a succession of sensing materials, at least some of which may have differing sensing properties, such as differing radiation sensitivities. The optical fiber may alternatively also include one or more of the sensing regions and one or more adjacent regions that are substantially free of the sensing material. The optical fiber typically is one continuous (not spliced) length of optical fiber.

The optical detector in accordance with embodiments of the present invention provides significant practical advantages. The accrual of charge provides improved signal to noise performance compared to scintillation-based devices. Further, regions at which portions of the optical fiber are spliced together typically are avoided, which reduces intensity losses of generated luminescent light. In addition, the sensing material of the sensing region typically is relatively long. The time integrated OSL intensity is dependent on the radiation dose and the time integration together with the length of the sensing region and the reduction in scattering losses enables detection of very low radiation doses at distributed locations.

Further, the optical fiber typically has a relatively small diameter, such as 125 μm or any other suitable small diameter, and may consequently conveniently be used for in-vivo detection of radiation doses (or changes thereof) to which a patient may be exposed during radiation treatment.

For example, the sensing material of the sensing region may have a width of typically 100 microns and a length of more than 1 mm, 10 mm, 100 mm, 200 mm, 500 m, or 1000 mmm or any other suitable length.

The optical detector typically is arranged such that the optical light guide guides light between the sensing region and the luminescence light detector and between the sensing region and the light source. In one embodiment the optical detector is arranged such that an optical path from the sensing region to the detector does not comprise a regional at which optical light guide portions are spliced together or otherwise coupled. The optical detector typically is arranged such that the optical light guide guides the light from the sensing material to the light detector without the need of a further light guide. It is to be appreciated, however, that in a less preferred variation of this embodiment the optical light guide may also be coupled (such as spliced) to a further optical light guide.

The sensing material typically is chosen such that a decay time of OSL that is emitted in response to an onset of stimulating light is shorter than 20, 10, 5, 2, 1 or less seconds. Consequently, a bleaching time of the optical detector is relatively short and the optical detector is suitable for fast repetitive measurements. As measurements may be repeated at a high rate, it is possible to detect a change in a radiation dose at substantially real time. Further, the sensing material typically is chosen such that meta-stable changes in properties associated with an intensity of luminescence light are avoided or can be neglected. Consequently, the optical detector in accordance with embodiments of the present invention offers the combined advantage of a relatively short bleaching times and no (or a negligible) increase of background intensity for repetitive measurements. In one specific embodiment these conditions are achieved by selecting a fluoride phosphate glass (also frequently referred to as fluorophosphate glass) that is arranged for trapping of charges as sensing material. The inventors have observed that fluoride phosphate glass enables almost entire bleaching within a relatively short period of time and has a response that is largely linear with respect to radiation dose.

The sensing material may also comprise a silicate glass that is arranged for trapping of charges. For example, the sensing material may comprise a soda-lime-silicate or a barium silicate.

The radiation response of the glasses may be tailored by doping using suitable dopants. Such suitable dopants include ions of selected rare earth elements or transition metals, for example Ce, Tb, Eu, Mn or Cu ions.

In one embodiment the optical light guide has a first end-portion that is coupled to the light source and the luminescence light detector. In an alternative embodiment the luminescence light detector is coupled to a first end of the optical light guide and the light source is coupled to a second end of the optical light guide. In either case coupling may be effected directly or indirectly.

The light source typically is a suitable laser.

The present invention provides in a second aspect an optical detector for detecting ionizing radiation, the detector comprising:

an optical light guide incorporating a sensing region, the sensing region comprising a sensing material that accrues trapped charge under exposure to the ionizing radiation and then emits stimulated luminescence radiation when the sensing material is stimulated; and

a luminescence light detector for detecting the emitted luminescence radiation;

wherein the sensing region comprises a fluoride phosphate glass.

The sensing region typically is incorporated in an optical fiber.

The invention will be more fully understood from the following description of specific embodiments of the invention. The description is provided with reference to the accompanying drawings.

### BRIEF DESCRIPTION OF THE DRAWINGS

FIGS. 1 and 2 show schematic representations of an optical detector in accordance with a specific embodiment of the present invention;

FIG. 3 shows a graph illustrating a typically response of an optical detector in accordance with a specific embodiment of the present invention;

FIGS. 4 and 5 show a graph illustrating radiation responses of optical detectors in accordance with embodiments of the present invention; and

FIG. 6 shows graphs illustrating a change in response of an optical detector as a function of dopant concentration in accordance with a specific embodiment of the present invention.

### DETAILED DESCRIPTION OF SPECIFIC EMBODIMENTS

Optically Stimulated Luminescence (OSL) can be used to detect ionizing radiation, such a β-radiation or other suitable types of ionizing radiation. An OSL material is exposed to the radiation, which generates electron-hole pairs in the OSL material. The electron-hole pairs are trapped at defects in the OSL material and stimulating light of a suitable wavelength can be used to initiate recombination of the electron-hole pairs, which results in emission of luminescence radiation. The time integrated OSL intensity is dependent on the radiation dose and consequently OSL can be used to detect ionizing radiation quantitatively.

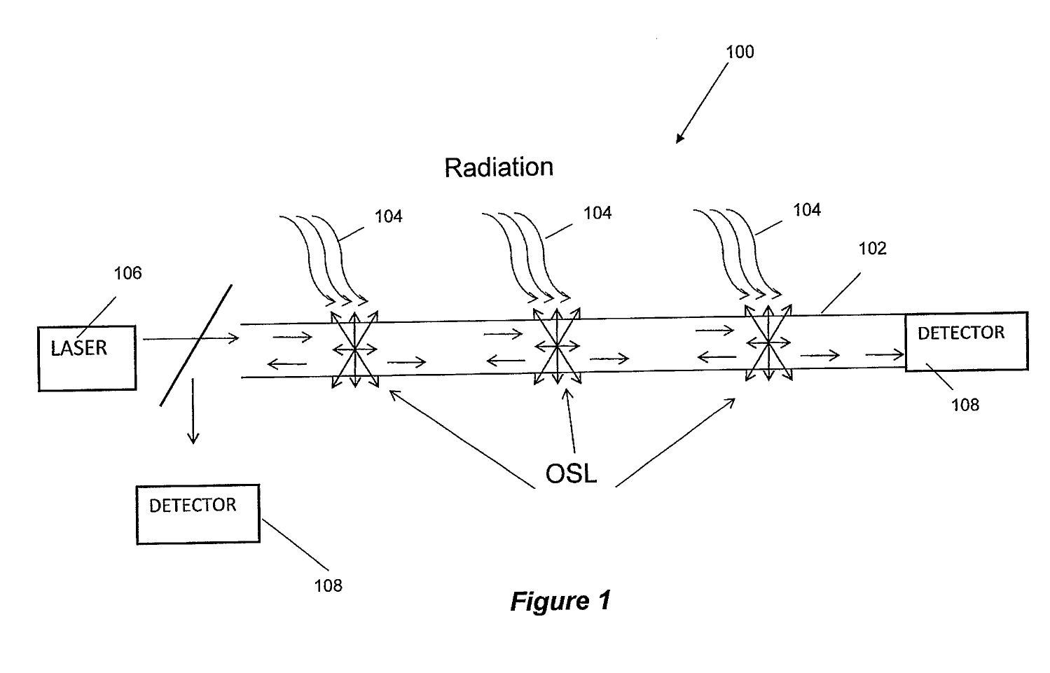

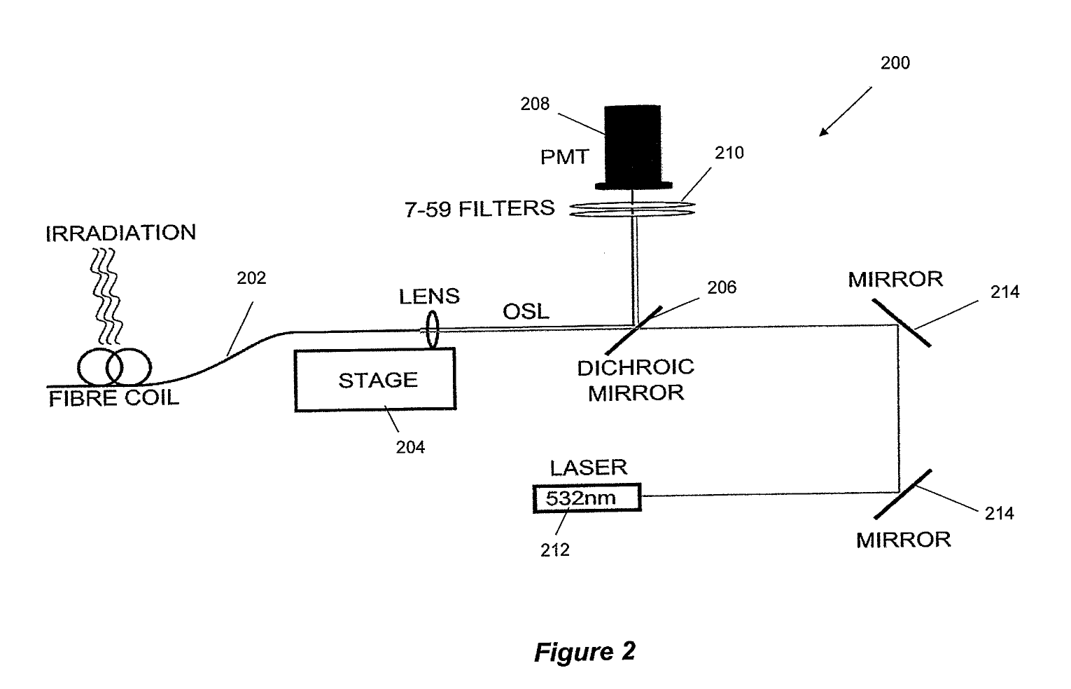

Referring now to FIGS. 1 and 2, an optical detector for detecting such ionizing radiation in accordance with a specific embodiment is now described. FIG. 1 shows a schematic of the optical detector 100 comprising an optical fiber 102. The optical fiber 102 is in use exposed to the ionizing radiation 104 and comprises an OSL material. Laser light from laser 106 is coupled into an end of the optical fiber 102 and provides light having a wavelength that is suitable for stimulating emission of luminescence light. The luminescent light is detected using detector 108, which may be coupled to the optical fiber 102 at an end that is opposite to that into which the laser light is coupled. Alternatively, the detector 108 may be positioned at the same end as the laser 106.

The optical fiber 102 comprises a core and cladding region. The optical fiber has in this embodiment an outer diameter of 125 μm and consequently is relatively narrow, which facilities use for in-vivo radiation dosimetry. Alternatively, the optical fiber 102 may have another suitable outer diameter.

In this embodiment the core region of the optical fiber 102 comprises a fluoride phosphate glass. The surrounding cladding region is formed from another suitable glass having a lower reflective index than the core region, but may alternatively also be formed from a suitable fluoride phosphate glass. The optical fiber 102 is integrally formed and drawn from a fluoride-phosphate glass preform. Specifically, the optical fiber 102 comprises in this embodiment no regions at which optical fiber portions are spliced together. Consequently, the optical fiber 102 provides the advantage that scattering losses due at spliced regions can be avoided.

Stimulating light that is directed from the laser 106 is directed through the sensing region of the optical fiber 102. Further, emitted luminescence light is also directed through the sensing region of the optical fiber 102. Consequently, the optical fiber 102 functions as a sensor and as an optical light guide.

FIG. 2 shows another schematic representation of an optical detector in accordance with a specific embodiment of the present invention. The optical detector 200 comprises optical fiber 202. The optical fiber 102 shown in FIG. 1 and the optical fiber 202 are identical. In this embodiment generated luminescence radiation exits an end of the optical fiber 202 and is directed by lens 204 and mirror 206 to luminescence light detector 208. Further, the optical detector 200 comprises a laser 212 that provides stimulating radiation that is directed via mirrors 214 and lens 204 to the sensing region of the optical fiber 202. Filters 210 filter the light such that generated luminescence radiation can reach the detector 208 and the stimulating light is blocked.

The inventors have observed that the OSL decay rate from the fluoride phosphate glass is very fast, and that the bleaching rate is also very fast. This follows from the electron traps being shallow, that is, they only weakly hold the electrons, and so not only do the optical stimulation photons untrap electrons with high efficiency, but also at ambient temperatures the material is effectively self-resetting because the trapped charges can leak away due to ambient thermal untrapping.

The fluoride phosphate glass of the optical fibers 102 or 202 has material properties that are constant along the length of the optical fibers 102 or 202. However, it is to be appreciated that alternatively the optical fibers 102 and 202 may comprise fluoride phosphate glass regions that have differing properties and offer a different response to radiation. The fluoride phosphate glass may be doped to tailor a response to radiation. Different regions of the optical fibers 102 and 202 may have different dopant concentrations. Further, the optical fibers 102 and 202 may comprise regions that are not formed from fluoride phosphate, but may be formed from another suitable material that typically is silica based.

In this embodiment the core region of the entire optical fiber is formed from a fluoride phosphate glass. Consequently, the sensing region of the optical detector typically is relatively long. As mentioned above, the optical fibers 102 or 202 do typically not comprise any regions in which fiber portions are spliced together and consequently scattering losses are minimized. In particular, the combination of the relatively long sensing region with the avoidance of scattering losses at regions at which fiber portions are spliced together makes the optical detector in accordance with embodiments of the present invention particularly useful for detection of low radiation doses at distributed locations.

It is to be appreciated that the optical detector in accordance with embodiments of the present invention may take many different forms. For example, the optical detector 100 or 200 may not necessarily comprise a laser, but stimulating light may be provided by a light emitting diode. Further, the stimulating light may not necessarily be coupled into the optical fibers 102 or 202 from an end portion of the optical fibers, but may be directed onto the sensing regions of the optical fibers from a transversal direction. The optical fiber 102 and 202 may have a suitable length, which may also be as short as a few millimeters.

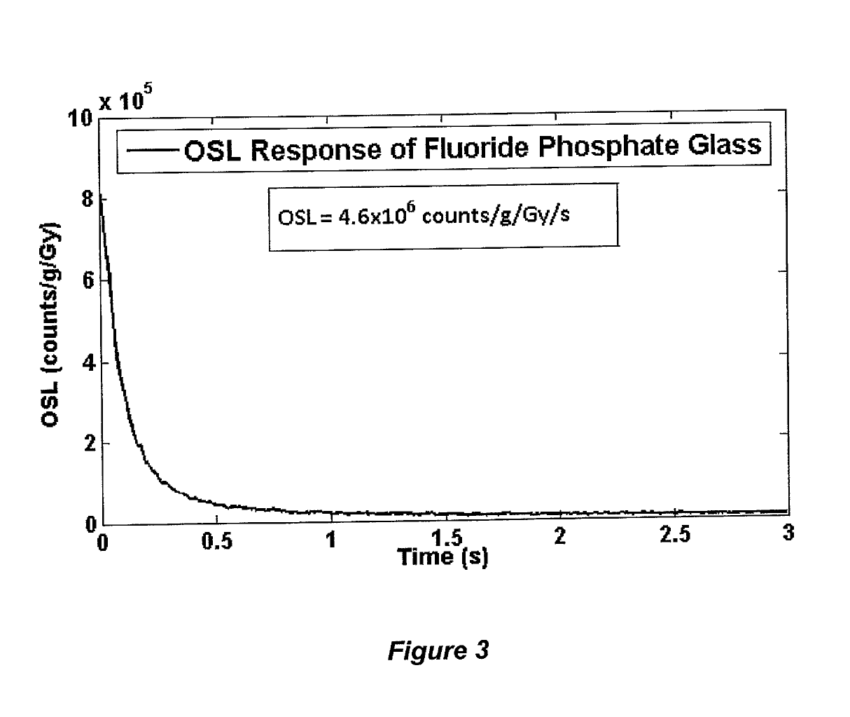

FIG. 3 shows a typical response curve of the optical detectors 100 or 200. The optical fibers 102 or 202 were exposed to ionizing radiation and stimulating laser light was subsequently directed to the sensing region, which resulted in emission of OSL as shown in FIG. 3. The inventors have observed that fluoride phosphate glass enables almost entire bleaching within a relatively short period of time (a few seconds or less) and consequently the optical detector in accordance with embodiments of the present invention is ideally suited for applications in which rapid repetitions of measurements are required.

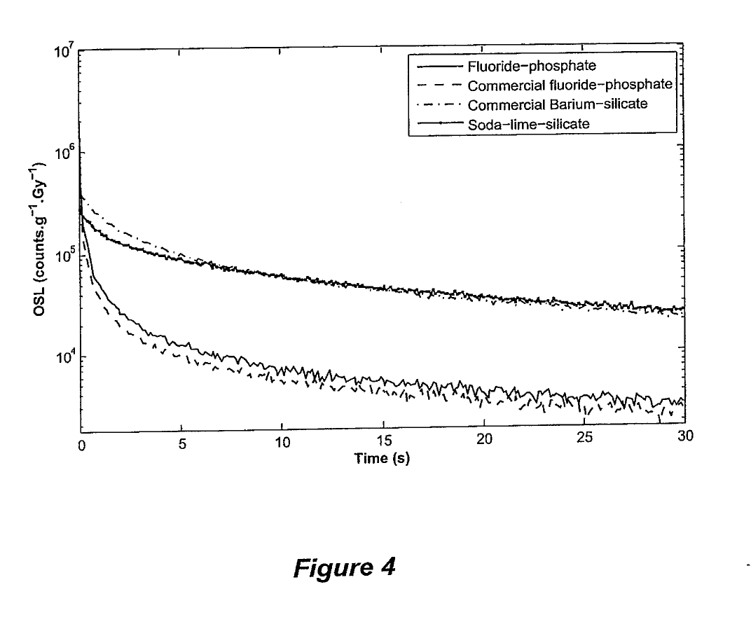

It will be appreciated that in variations of the above-described embodiment the sensing region of the optical fiber may comprise glasses other than fluoride phosphate glass. For example, silicate glasses may be used. FIG. 4 shows response curves for soda-lime silicate, barium silicate and two examples of fluoride phosphate glasses.

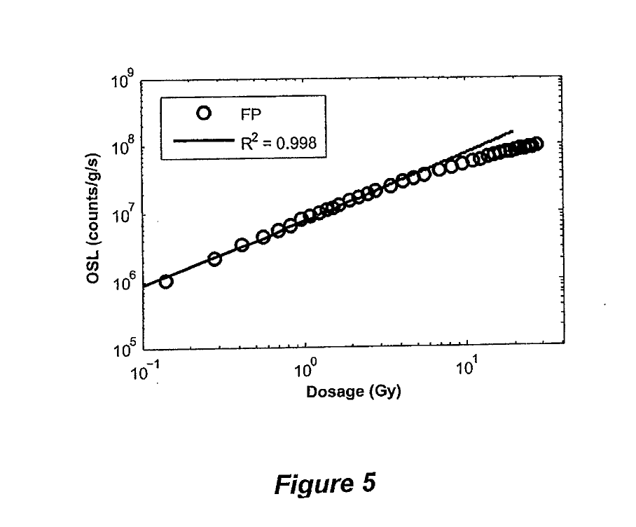

FIG. 5 illustrates an integrated luminescence response of an optical detector in accordance with a specific embodiment of the present invention. FIG. 5 shows the time integrated luminescence light as a function of dose for an optical fiber detector comprising fluoride phosphate glass. The composition of that fluoride phosphate glass is as follows: O (13 atomic %), F (55 atomic %), Mg (3 atomic %), Al (10 atomic %), P (3 atomic %), Ca (9 atomic %), Sr (7 atomic %). The inventors have observed that melting of the glass in a reducing atmosphere facilitates incorporation of defects and results in a higher luminescence yield. As can been seen from FIG. 5, the OSL responses are largely linear with respect to radiation dose and consequently the integrated OSL response is a measure for the radiation dose to which the sensing region of an optical detector in accordance with the present invention is exposed.

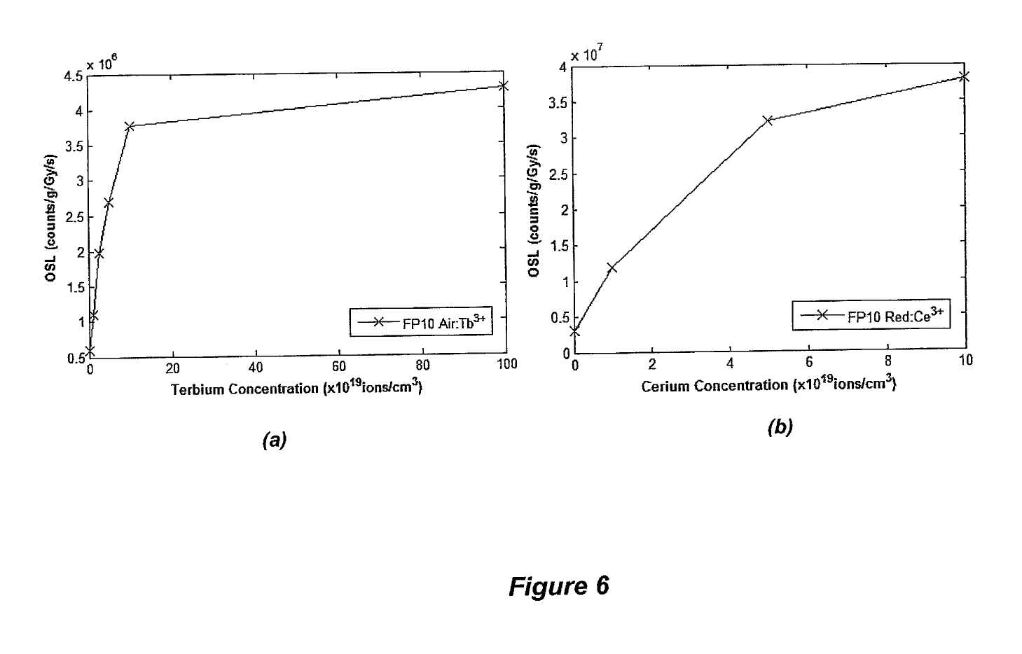

FIG. 6 shows an integrated OSL response as a function of dopant concentration. As mentioned above, doping the fluoride phosphate glass can tailor the response characteristics. FIG. 6 (a) shows the integrated OSL responses for Terbium dopant concentrations up to 100×10¹⁹ ions/cm³. FIG. 6 (b) shows the integrated OSL response for Cerium dopant concentration of up to 10×10¹⁹ ions/cm³. As can be seen by comparing FIGS. 6(a) and 6 (b), the fluoride phosphate material that is doped with Cerium results in a higher radiation response. Other suitable doping materials include selected Rare Earth materials and transition metals.

It is to be appreciated that the present invention may be provided in many different forms. For example, the optical apparatus may not necessarily comprise an optical fiber but may alternatively comprise a planar optical waveguide.

1. An optical detector for detecting ionizing radiation, the detector comprising:
an optical light guide incorporating a sensing region, the sensing region comprising a sensing material that accrues trapped charge under exposure to the ionizing radiation and then emits stimulated luminescence radiation when the sensing material is stimulated; and
a luminescence light detector for detecting the emitted luminescence radiation;
wherein the optical light guide is arranged to guide light through the sensing region and between the sensing region and the luminescence light detector.

2. The optical detector of claim 1 comprising a light source for optically stimulating the accrued charges of the sensing material thereby emitting optically stimulated luminescence (OSL) radiation.

3. The optical detector of claim 1 wherein the optical light guide is integrally formed.

4. The optical detector of claim 1 wherein the optical light guide is an optical fiber that comprises a core and a cladding region.

5. The optical detector of claim 4 wherein the sensing region forms a part of the core region of the optical fiber.

6. The optical detector of claim 4 wherein the sensing region extends along the entire length of the optical fiber.

7. The optical detector of claim 4 being one continuous length of optical fiber.

8. The optical detector of claim 1 wherein the sensing material of the sensing region has a length of at least 10 mm.

9. The optical detector of claim 1 wherein the sensing material of the sensing region has a length of at least 100 mm.

10. The optical detector of claim 1 wherein the sensing material of the sensing region has a length of at least 500 mm.

11. The optical detector of claim 1 wherein the optical detector comprises a light source and wherein the optical detector is arranged such that the optical light guide guides light between the sensing region and the light source.

12. The optical detector of claim 1 wherein the sensing material is chosen such that a decay time of luminescence radiation that is emitted in response to an onset of stimulating light is shorter than 10 seconds.

13. The optical detector of claim 1 wherein the sensing material is chosen such that a decay time of luminescence radiation that is emitted in response to an onset of stimulating light is shorter than 5 seconds.

14. The optical detector of claim 1 wherein the sensing material is chosen such that a decay time of luminescence radiation that is emitted in response to an onset of stimulating light is shorter than 2 seconds.

15. The optical detector of claim 1 wherein the sensing material comprises a fluoride phosphate glass that is arranged for trapping of charges.

16. The optical detector of claim 1 wherein the sensing material comprises a silicate glass that is arranged for trapping of charges.

17. The optical detector of claim 15 wherein the radiation response of the fluoride phosphate glass is tailored by doping using suitable dopants.

18. The optical detector of claim 17 wherein the suitable dopants include ions of rare earth elements or transition metals.

19. The optical detector of claim 1 wherein the optical light guide has a first end-portion that is directly or indirectly coupled to the light source and the luminescence light detector.

20. The optical detector of any one of claim 1 wherein the luminescence light detector is directly or indirectly coupled to a first end of the optical light guide and the light source is coupled to a second end of the optical light guide.

21. The optical detector claim 1 wherein the optical detector is arranged such that an optical path from the sensing region to the detector does not comprise a region at which optical light guide portions are spliced together or otherwise coupled.

22. An optical detector for detecting ionizing radiation, the detector comprising:
an optical light guide incorporating a sensing region, the sensing region comprising a sensing material that accrues trapped charge under exposure to the ionizing radiation and then emits stimulated luminescence radiation when the sensing material is stimulated; and
a luminescence light detector for detecting the emitted luminescence radiation;
wherein the sensing region comprises a fluoride phosphate glass.

23. The optical detector of claim 22 wherein the sensing region is incorporated in an optical fiber.
